(19) United States
(12) Patent Application Publication
(10) Pub. No.: US 2026/0025446 A1
(43) Pub. Date: Jan. 22, 2026

(54) WI-FI SENSING-BASED CALL ALERTS

(71) Applicant: ARRIS Enterprises LLC, Horsham, PA (US)

(72) Inventors: Sundar Murthy TUMULURU, Bangalore (IN); Kurt A. LUMBATIS, Dacula, GA (US)

(21) Appl. No.: 18/993,165

(22) PCT Filed: Jun. 30, 2023
(86) PCT No.: PCT/US2023/026689

§ 371 Date: Jan. 10, 2025

Related U.S. Application Data
(60) Provisional application No. 63/389,515, filed on Jul. 15, 2022.

(51) Int. Cl. H04M 1/00; H04M 1/72412; H04M 1/72457; H04M 3/42

(52) U.S. Cl. CPC H04M 1/006; H04M 1/72412; H04M 1/72457; H04M 3/42348

(57) ABSTRACT

A media device for use with a wide area network, a local area network, a local client device, a second client device, a wireless speaker, and a user of the local client device, the local client device being configured to receive the initiation communication and to transmit an alerting communication, said media device comprising: a memory; a communication system configured to receive the alerting communication from the local client device; a processor configured to execute instructions stored on said memory to cause said media device to: determine a user location of the user via the local area network; determine a client device location of the local client device via the local area network; and transmit, when the user location differs from the client device location, a speaker instruction to the wireless speaker to cause to the wireless speaker to output the warning, based on the alerting communication.

### BACKGROUND

Embodiments of the invention relate to alerting a user of a phone call.

### SUMMARY

Aspects of the present disclosure are drawn to a media device for use with a wide area network, a local area network, a local client device, a second client device, a wireless speaker, and a user of the local client device. The second client device is configured to transmit an initiation communication to initiate communication with the local client device. The local client device is configured to receive the initiation communication and to transmit an alerting communication, the local client device being at a first location. The wireless speaker is configured to output a warning. The media device includes: a memory; a communication system configured to receive the alerting communication from the local client device; and a processor. The processor is configured to execute instructions stored on the memory to cause the media device to: determine a user location of the user via the local area network; determine a client device location of the local client device via the local area network; and transmit, when the user location differs from the client device location, a speaker instruction to the wireless speaker to cause to the wireless speaker to output the warning, based on the alerting communication.

In some embodiments, the wireless speaker is additionally configured to output a location instruction based on a location of the local client device, and the processor is configured to execute instructions stored on the memory to additionally cause the media device to transmit a second instruction to the speaker, based on the alerting communication, to cause the speaker to output the location instruction.

In some embodiments, the processor is configured to execute instructions stored on the memory to additionally cause the media device to transmit a predetermined message instruction to the wireless speaker to cause the wireless speaker to output a predetermined message.

In some embodiments, the media device is for use with a second wireless speaker being configured to output the alerting instruction, the wireless speaker being a first distance from the user location, the second wireless speaker being a second distance from the user location. The processor is configured to execute instructions stored on the memory to additionally cause the media device to: transmit the speaker instruction to the wireless speaker to cause to the wireless speaker to output the warning, based on the alerting communication, when the user location differs from the client device location and when the first distance is less than or equal to the second distance; and transmit the speaker instruction to the second wireless speaker to cause to the second wireless speaker to output the warning, based on the alerting communication, when the user location differs from the client device location and when the first distance is greater than the second distance.

In some embodiments, the media device further includes a microphone configured to receive a vocal instruction from the user. The processor is configured to execute instructions stored on the memory to additionally cause the media device to, in response to receiving the vocal instruction from the user, create a communication channel between the local client device and the second client device via the microphone.

In some embodiments, the media device further includes an image detector configured to detect a first image of the user. The processor is configured to execute instructions stored on the memory to cause the media device to transmit, when the user location differs from the client device location and when the image detector detects the first image of the user, a first speaker instruction to the microphone to cause to the microphone to open a communication channel with the second client device.

Other aspects of the present disclosure are drawn to a method of using a media device with a wide area network, a local area network, a local client device, a second client device, a wireless speaker, and a user of the local client device. The second client device is configured to transmit an initiation communication to initiate communication with the local client device. The local client device is configured to receive the initiation communication and to transmit an alerting communication, the local client device being at a first location. The wireless speaker is configured to output a warning. The method includes: receiving, via a communication system, the alerting communication from the second client device; determining, via a processor configured to execute instructions stored on a memory, a user location of the user via the local area network; determining, via the processor, a client device location of the local client device via the local area network; receiving, via the processor, the alerting communication from the local client device; and transmitting, via the processor, when the user location differs from the client device location, a speaker instruction to the wireless speaker to cause to the wireless speaker to output the warning, based on the alerting communication.

In some embodiments, the method, wherein the wireless speaker is additionally configured to output a location instruction based on a location of the local client device, the method further includes transmitting, via the processor, a location instruction to the speaker, based on the alert communication, to cause the speaker to output the location instruction.

In some embodiments, the method further includes transmitting, via the processor, a predetermined message instruction to the wireless speaker to cause the wireless speaker to output a predetermined message.

In some embodiments, the method, for additional use with a second wireless speaker being configured to output the alerting instruction, the wireless speaker being a first distance from the user location, the second wireless speaker being a second distance from the user location, further includes: transmitting, via the processor, the speaker instruction to the wireless speaker to cause to the wireless speaker to output the warning, based on the alerting communication, when the user location differs from the client device location and when the first distance is less than or equal to the second distance; and transmitting, via the processor, the speaker instruction to the speaker to cause to the wireless speaker to output the warning, based on the alerting communication, when the user location differs from the client device location and when the first distance is greater than the second distance.

In some embodiments, the method further includes: receiving, via a microphone, a vocal instruction from the user; and in response to receiving the vocal instruction from the user, creating a communication channel between the local client device and the second client device via the wireless speaker.

In some of these embodiments, the method further includes: detecting, via an image detector, one of a first image of the user and a second image of the user; and transmitting, via the processor when the user location differs from the client device location and when the image detector detects the first image of the user, a first speaker instruction to microphone to cause to the microphone to open a communication channel with the second client device.

Other aspects of the present disclosure are drawn to a non-transitory, computer-readable media having computer-readable instructions stored thereon, the computer-readable instructions being capable of being read by a media device for use with a wide area network, a local area network, a local client device, a second client device, a wireless speaker, and a user of the local client device. The second client device is configured to transmit an initiation communication to initiate communication with the local client device. The local client device is configured to receive the initiation communication and to transmit an alerting communication, the local client device being at a first location. The wireless speaker is configured to output a warning. The computer-readable instructions are capable of instructing the client device to perform the method including: receiving, via a communication system, the alerting communication from the second client device; determining, via a processor configured to execute instructions stored on a memory, a user location of the user via the local area network; determining, via the processor, a client device location of the local client device via the local area network; receiving, via the processor, the alerting communication from the local client device; and transmitting, via the processor, when the user location differs from the client device location, a speaker instruction to the wireless speaker to cause to the wireless speaker to output the warning, based on the alerting communication.

In some embodiments, the wireless speaker is additionally configured to output a location instruction based on a location of the local client device. The computer-readable instructions are capable of instructing the client device to perform the method further comprising transmitting, via the processor, a location instruction to the speaker, based on the alert communication, to cause the speaker to output the location instruction.

In some embodiments, the computer-readable instructions are capable of instructing the client device to perform the method further comprising transmitting, via the processor, a predetermined message instruction to the wireless speaker to cause the wireless speaker to output a predetermined message.

In some embodiments, a second wireless speaker is configured to output the alerting instruction, the wireless speaker being a first distance from the user location, the second wireless speaker being a second distance from the user location. The computer-readable instructions are capable of instructing the client device to perform the method further comprising: transmitting, via the processor, the speaker instruction to the wireless speaker to cause to the wireless speaker to output the warning, based on the alerting communication, when the user location differs from the client device location and when the first distance is less than or equal to the second distance; and transmitting, via the processor, the speaker instruction to the speaker to cause to the wireless speaker to output the warning, based on the alerting communication, when the user location differs from the client device location and when the first distance is greater than the second distance.

In some embodiments, the computer-readable instructions are capable of instructing the client device to perform the method further including: receiving, via a microphone, a vocal instruction from the user; and in response to receiving the vocal instruction from the user, creating a communication channel between the local client device and the second client device via the wireless speaker.

In some embodiments, the computer-readable instructions are capable of instructing the client device to perform the method further comprising: detecting, via an image detector, one of a first image of the user and a second image of the user; and transmitting, via the processor when the user location differs from the client device location and when the image detector detects the first image of the user, a first speaker instruction to microphone to cause to the microphone to open a communication channel with the second client device.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a method for Wi-Fi sensing-based call alerts in accordance with aspects of the present disclosure;

FIG. 2A illustrates a communication network at time to in accordance with aspects of the present disclosure;

FIG. 2B illustrates a communication network at time t₁ in accordance with aspects of the present disclosure;

FIG. 3 illustrates an exploded view of a local client device, a gateway device, and an extender in accordance with aspects of the present disclosure;

FIG. 4A illustrates an example embodiment of a residence in accordance with aspects of the present disclosure; and

FIG. 4B illustrates an example embodiment of a residence in accordance with aspects of the present disclosure.

### DETAILED DESCRIPTION

Sometimes, cell phone and mobile device owners will be preoccupied when they receive a phone call. In particular, elderly people or children are most susceptible to not paying attention to their mobile devices if they are not directly using them. This is especially true when they are preoccupied with another task, or when their mobile device is not directly on their person. Missing a phone call can be problematic when the incoming phone call is urgent. Further, the caller may panic and assume something is wrong if they were expecting the mobile device owner to answer. As such, there needs to be a way to immediately get the attention of a user when they are unable to answer the call to ensure that the incoming phone call is received.

What is needed is a system and method for notifying a user of a phone call from an outside user.

A system and method in accordance with the present disclosure notifies a user of a phone call from an outside user.

In accordance with the present disclosure, an outside user operates an outside client device to call the local client device of a local user. The local client device, connected to a gateway device, will notify a gateway device of an incoming phone call and transmit both the caller credentials of the outside client device and the mode of operation of the local client device, informing the gateway device of whether the local client device has the ringer on or off. The gateway device will determine the location of the local user through known Wi-Fi sensing methods. If the ringer of the local client device is off, the gateway device, knowing the location of the local user, will transmit the caller credentials to an extender and instruct the extender to transmit the caller credentials to a speaker and microphone device nearby to the local user. The extender will then transmit the caller credentials to any speaker and microphone device closest to the local user. The speaker will alert the local user of the incoming phone call, in which the user can use the microphone to respond to call.

If the ringer of the local client device is on, the gateway device will compare the location of the local client device to the location of the local user. If the locations are different, the gateway device will transmit the caller credentials to an extender and instruct the extender to transmit the caller credentials to the speaker and microphone device closest to the local user. The extender will then transmit the caller credentials to the speaker and microphone device closest to the local user. The speaker will alert the local user of the incoming phone call, in which the user can use the microphone to respond to call.

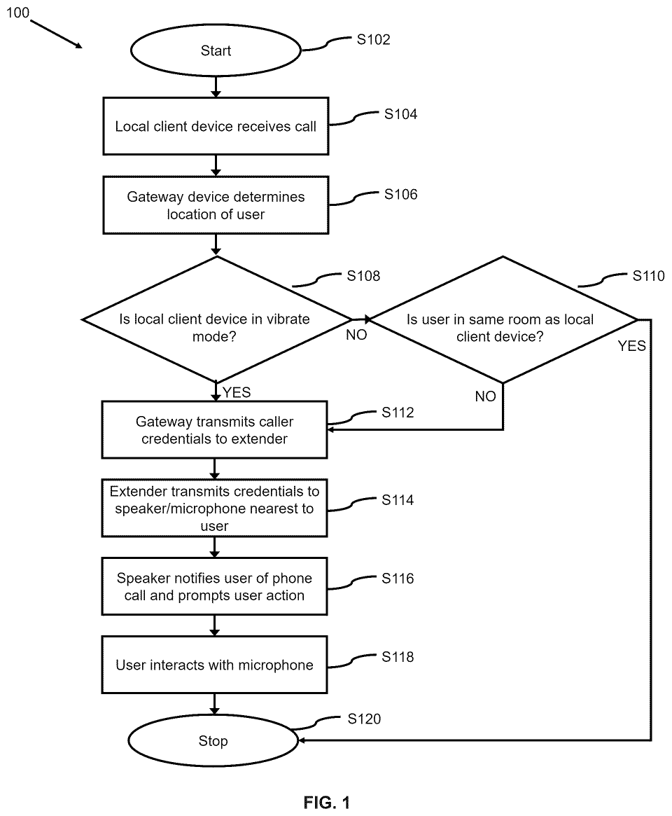

An example system and method for alerting a user of a phone call in accordance with aspects of the present disclosure will now be described in greater detail with reference to FIGS. 1-4B.

FIG. 1 illustrates method 100 for Wi-Fi sensing-based call alerts in accordance with aspects of the present disclosure.

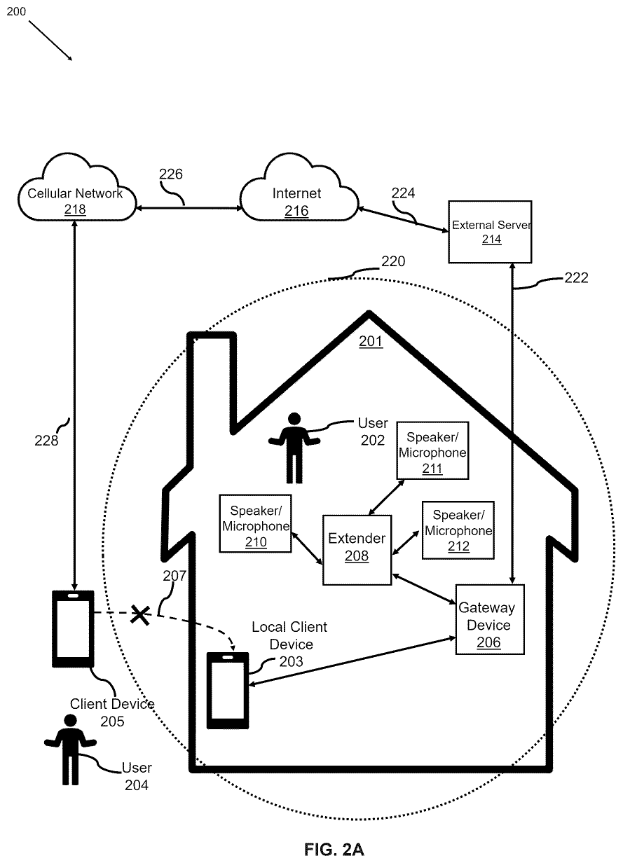

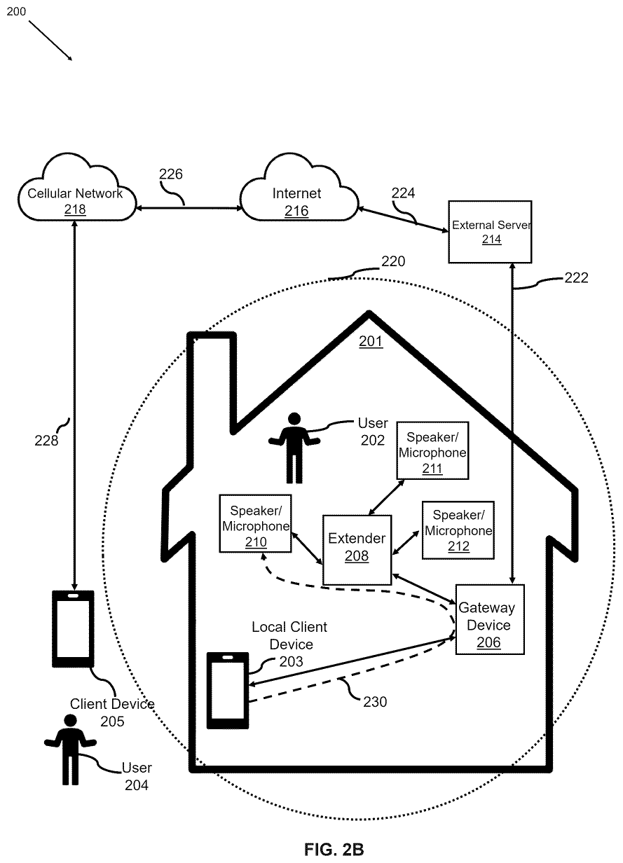

As shown in FIG. 1, method 100 starts (S102) and the local client device receives a call (S104). This will be described in greater detail with reference to FIG. 2A.

FIG. 2A illustrates a communication network 200 at time to in accordance with aspects of the present disclosure.

As shown in FIG. 2A, communication network 200 includes: a residence 201; a user 202; a local client device 203; a user 204; a client device 205; a gateway device 206; an attempt to initiate communication 207; an extender 208; speaker/microphone devices 210, 211, and 212; an external server 214; Internet 216; a cellular network 218; a WLAN 220; and communication channels 222, 224, 226, and 228.

Gateway device 206, also referred to as a gateway, residential gateway, or RG, is an electronic device that is disposed so as to establish a local area network (LAN) at a consumer premises. The consumer premises can include a residential dwelling, office, or any other business space of a user, such as residence 201. The terms home, office, and premises may be used synonymously herein.

Gateway device 206 may be any device or system that is configured to allow data to flow from one discrete network to another, which in this example is from WLAN 220 to external server 214. Gateway device 206 may perform such functions as web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Gateway device 206 establishes, or is part of, WLAN 220, using Wi-Fi for example, such that local client device 203, extender 208, speaker/microphone device 210, speaker/microphone device 211, and speaker/microphone device 212 are able to communicate wirelessly with gateway device 206. In particular, gateway device 206 is able to communicate wirelessly directly with local client device 203. The term Wi-Fi as used herein may be considered to refer to any of Wi-Fi 4, 5, 6, 6E, or any variation thereof.

Further, it should be noted that gateway device 206 is able to communicate with external server 214 via communication channel 222, which may optionally be a wireless communication system, such as 4G, or 5G, and further is able to connect to Internet 216.

Gateway device 206 serves as a gateway or access point to Internet 216 for one or more electronic devices, referred to generally herein as local client device 203, that wirelessly communicate with gateway device 206 via, e.g., Wi-Fi. Local client device 203 can be a desk top computer, laptop computer, electronic tablet device, smart phone, appliance, or any other so-called internet of things equipped devices that are equipped to communicate information via WLAN 220.

A wireless access point (WAP), or more generally just access point (AP), is a networking hardware device that allows other Wi-Fi devices to connect to a Wi-Fi network. A service set ID (SSID) is an identification (in IEEE 802.11) that is broadcast by access points in beacon packets to announce the presence of a network access point for the SSID. SSIDs are customizable IDs that can be zero to 32 bytes, and can be in a natural language, such as English. In WLAN 220, gateway device 206 and extender 208 are access points for WLAN 220.

Extender 208 is connected to gateway device 206. An extender is a wireless network device that is able to join the wireless network of gateway device 206, extend the reach of the wireless network within residence 201, and transpond data between Internet devices within residence 201 and gateway device 206 in situations when those client devices are not sufficiently close to gateway device 206 so as to communicate directly with gateway device 206. For extenders to provide this feature, they must first join the network of the gateway device.

Speaker/microphone devices 210, 211, and 212 may be any devices capable of receiving audio input and transmitting audio output. Speaker/microphone devices 210, 211, and 212 are able to connect to WLAN 220 wirelessly. Speaker/microphone devices 210, 211, and 212 are all illustrated as unitary devices, but they may be separated. In some embodiments, residence 201 may have more or less speaker/microphone devices.

Speaker/microphones device 210, 211, and 212 alert user 202 of incoming phone calls to local client device 203. User 202 can respond to the call through speaker/microphone devices 210, 211, and 212, all of which are preconfigured with commands for user 202 to use to acknowledge the call. This will be described in greater detail with reference to S118 of FIG. 1.

User 202 is associated with local client device 203, and user 204 is associated with client device 205.

Local client device 203 is configured to transmit a mode of operation signal to gateway device 206. The mode of operation signal will allow gateway device 206 to determine if local client device 203 is operating in the silent mode of operation or the normal mode of operation. This will be described in greater detail with reference to S108 of FIG. 1.

For example, presume that user 204 operates client device 205 and attempts to contact user 202, who is associated with local client device 203. However, as shown in FIG. 2A, user 202 is not near local client device 203. Therefore, given that user 204 is attempting to contact user 202 by using client device 205 to call local client device 203, user 202 cannot answer the call to local client device 203, shown as attempt to initiate communication 207. Gateway device 206, being connected to local client device 203, will obtain the caller credentials of user 204.

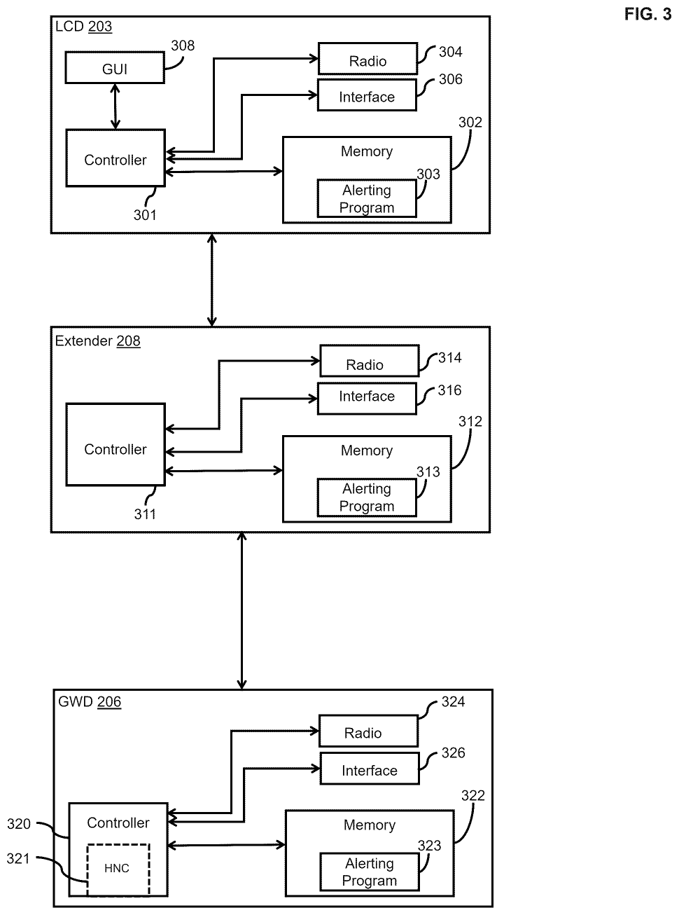

Returning to FIG. 1, after the local client device receives a call (S104), the gateway device determines the location of the user (S106). This will be described in greater detail with reference to FIG. 3.

FIG. 3 illustrates an exploded view of local client device 203, gateway device 206, and extender 208 in accordance with aspects of the present disclosure.

As shown in FIG. 3, local client device 203 includes: a controller 301; a memory 302, which has stored therein an alerting program 303; and at least one radio, a sample of which is illustrated as a radio 304; an interface 306; and a graphic user interface (GUI) 308.

In this example, controller 301, memory 302, radio 304, interface 306 and GUI 308 are illustrated as individual devices. However, in some embodiments, at least two of controller 301, memory 302, radio 304, interface 306 and GUI 308 may be combined as a unitary device. Further, in some embodiments, at least one of controller 301 and memory 302 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large-scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 301 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of local client device 203 in accordance with the embodiments described in the present disclosure.

Memory 302, as will be described in greater detail below, has instructions, including alerting program 303, stored therein to be executed by controller 301 causing local client device 203 to: transmit the mode of operation of local client device 203; analyze phone calls; and transmit the caller credentials to gateway device 206. Local client device 203 may operate in a silent mode of operation (e.g., vibrate mode) or a normal mode of operation (e.g., where the ringer is active).

Radio 304 may include a Wi-Fi WLAN interface radio transceiver that is configured to communicate with extender 208 and with gateway device 206 as shown in FIG. 2 and also may include a cellular transceiver configured to communicate with cellular network 218. Radio 304 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Local client device 203 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHZ bands or 60 GHz bands, RF4CE protocol, ZigBee protocol, Z-Wave protocol, or IEEE 802.15.4 protocol.

Interface 306 can include one or more connectors, such as RF connectors, or Ethernet connectors, and/or wireless communication circuitry, such as 5G circuitry and one or more antennas

GUI 308 may be any known device or system to display an interactive image to user 204 to enable user 204 to interact with local client device 203.

In some embodiments, residence 201 may include more local client devices. In the event that a local client device within WLAN 220 is not a mobile device similar to local client device 203, such a client device may still include: a controller, which can include a dedicated hardware circuitry such as a dedicated control circuit, CPU, microprocessor, etc., and that controls the circuits of the client device; a memory, which has stored therein an alerting program, that is similar to memory 302 and alerting program 303, respectively, of local client device 203 discussed above; a radio similar to radio 304 of local client device 203 discussed above; in additional to further functional circuitry. Accordingly, any of the client devices may include a Wi-Fi WLAN interface radio transceiver, that is configured to communicate with other client devices and with gateway device 206, as shown in FIG. 2A and also may include a cellular transceiver configured to communicate with cellular network 218. Further, any of the client devices may include a radio that is similar to radio 304 of local client device 203 discussed above. Still further, any of the client devices may be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol, in a manner similar to local client device 203 discussed above.

As shown in FIG. 3, extender 208 includes: a controller 311; a memory 312, which has stored therein an alerting program 313; and at least one radio, a sample of which is illustrated as a radio 314; and an interface 316.

In this example, controller 311, memory 312, radio 314, and interface 316 are illustrated as individual devices. However, in some embodiments, at least two of controller 311, memory 312, radio 314, and interface 316 may be combined as a unitary device. Further, in some embodiments, at least one of controller 311 and memory 312 may be implemented as a computer having tangible computer-readable media for carrying or having computer-executable instructions or data structures stored thereon.

Controller 311 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of extender 208 in accordance with the embodiments described in the present disclosure.

Memory 312, as will be described in greater detail below, has instructions, including alerting program 313, stored therein to be executed by controller 311 to cause extender 208 to: receive caller credentials from gateway device 206; receive the location of the optimal speaker/microphone; and transmit the caller credentials to the optimal speaker/microphone.

Radio 314, may include a Wi-Fi WLAN interface radio transceiver that is configured to communicate with gateway device 206, as shown in FIG. 2A. Radio 314 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 314 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 316 can include one or more connectors, such as RF connectors, or Ethernet connectors, and/or wireless communication circuitry, such as 5G circuitry and one or more antennas

Gateway device 206 includes: a controller 320, which may have stored therein a home network controller (HNC) 321; a memory 322, which has stored therein an alerting program 323; and at least one radio, a sample of which is illustrated as a radio 324; and an interface 326.

In this example, controller 320, memory 322, radio 324, and interface 326 are illustrated as individual devices. However, in some embodiments, at least two of controller 320, memory 322, radio 324, and interface 326 may be combined as a unitary device. Further, in some embodiments, at least one of controller 320 and memory 322 may be implemented as a computer having tangible computer-readable media for carrying or having computer-executable instructions or data structures stored thereon.

Controller 320 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the gateway device 206 in accordance with the embodiments described in the present disclosure.

Controller 320 running HNC 321 is additionally configured to tag locations within residence 201, and to tag devices to these locations. Controller 320 running HNC 321 is configured to detect the location of user 202 through known Wi-Fi sensing methods, a non-limiting example of which is discussed in U.S. utility patent application Ser. No. 17/689,177, filed on Mar. 8, 2022, the entire disclosure of which is incorporated herein by reference. For example, through the use of machine learning and data analysis, controller 320 running HNC 321 may cause gateway device 206 to determine the location of user 202 at any given time. For example, presume that user 202 sleeps in their bedroom from 10:00 pm to 6:00 am every day. Gateway device 206 may tag that location as the bedroom. Further, if local client device 203 were to receive a phone call at 11:00 pm, gateway device 206 would determine that user 202 is in their bedroom.

HNC 321 controls gateway device 206 within the wireless network. HNC 321 may perform tasks such as steering connected devices, a non-limiting example of which is a smart television, from one access point to another.

Memory 322, as will be described in greater detail below, has instructions, including alerting program 323, stored therein to be executed by controller 320 to cause gateway device 206 to: determine a user location of user 204 via the local area network; determine a client device location of local client device 203 via the local area network; and transmit, when the user location differs from the client device location, a speaker instruction to the optimal speaker/microphone to cause the speaker to output the warning, based on the alerting communication.

In some embodiments, wherein the speaker/microphone is configured to output a location instruction based on a location of local client device 203, memory 322, as will be described in greater detail below, has instructions, including alerting program 323, stored therein to be executed by controller 320 to cause gateway device 206 to: transmit a second instruction to the speaker/microphone, based on the alerting communication, to cause the speaker/microphone to output the location instruction.

In some of these embodiments, memory 322, as will be described in greater detail below, has instructions, including alerting program 323, stored therein to be executed by controller 320 to cause gateway device 206 to: transmit a predetermined message instruction to the speaker/microphone to cause the speaker to output a predetermined message.

In some embodiments, during the use of a second speaker/microphone configured to output the alerting instruction, the speaker/microphone being a first distance from user 202 location, and the second speaker/microphone being a second distance from user 202, memory 322, as will be described in greater detail below, has instructions, including alerting program 323, stored therein to be executed by controller 320 to cause gateway device 206 to: transmit the speaker instruction to the speaker/microphone to cause the speaker to output the warning, based on the alerting communication, when the location of user 202 differs from the location of local client device 203 and when the first distance is less than or equal to the second distance; and transmit the speaker instruction to the second wireless speaker/microphone to cause to the second wireless speaker/microphone to output the warning, based on the alerting communication, when the user location differs from the client device location and when the first distance is greater than the second distance.

In some embodiments, memory 322, as will be described in greater detail below, has instructions, including alerting program 323, stored therein to be executed by controller 320 to cause gateway device 206 to, in response to receiving the vocal instruction from user 202, creating a communication channel between local client device 203 and client device 205 via the speaker/microphone.

In some embodiments, during the use of an image detector to detect the image of user 202, memory 322, as will be described in greater detail below, has instructions, including alerting program 323, stored therein to be executed by controller 320 to cause gateway device 206 to: transmit, when the user location differs from the client device location and when the image detector detects the first image of user 202, a first speaker instruction to the speaker/microphone to cause the speaker/microphone to open a communication channel with the client device 205.

Radio 324 may also be referred to as a wireless communication circuit, such as a Wi-Fi WLAN interface radio transceiver and is configured to communicate with extender 208, local client device 203, and external server 214. Radio 324 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Gateway device 206 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol.

Interface 326 can include one or more connectors, such as RF connectors, or Ethernet connectors, and/or wireless communication circuitry, such as 5G circuitry and one or more antennas. Interface 326 receives content from external server 214 (as shown in FIGS. 2A and 2B) by known methods, non-limiting examples of which include terrestrial antenna, satellite dish, wired cable, DSL, optical fibers, or 5G as discussed above. Through interface 326, gateway device 206 receives an input signal, including data and/or audio/video content, from external server 214 and can send data to external server 214.

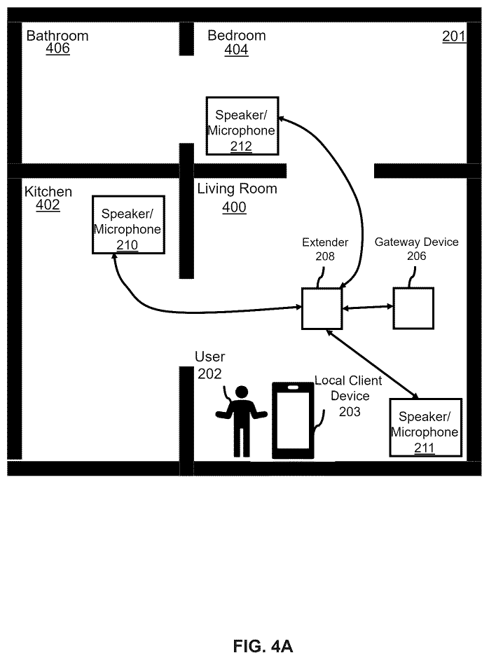

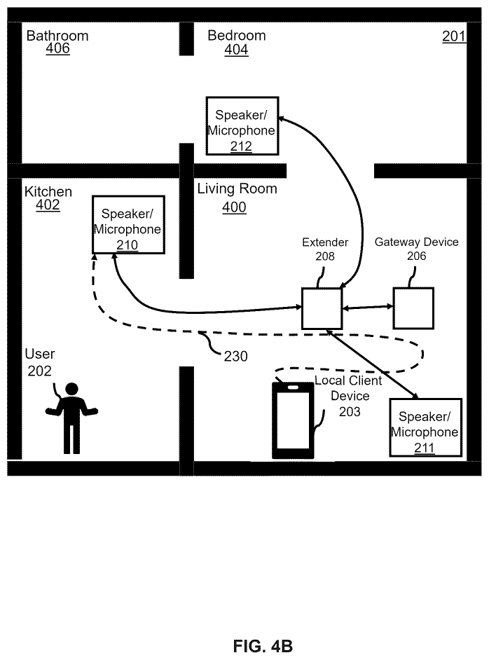

For example, with reference to FIG. 3, presume that user 204, operating client device 205, is calling local client device 203. Controller 301 will execute instructions stored on memory 302 causing local client device 203 to transmit the caller credentials to gateway device 206. Controller 321 will execute instructions stored on memory 322 causing gateway device 206 determine the location of user 202. This will be described in greater detail with reference to FIG. 4A.

Returning to FIG. 1, after the gateway device determines the location of the user (S106), it is determined if the local client device is in vibrate mode (S108). This will be described in greater detail with reference to FIG. 4A.

FIG. 4A illustrates an example embodiment of residence 201 in accordance with aspects of the present disclosure.

As shown in FIG. 4A, residence 201 includes: a living room 400; a kitchen 402; a bedroom 404; and a bathroom 406. User 202 is nearby local client device 203. Presume also that local client device 203 is not on vibrate mode. If user 204 were to make a call, using client device 205, to local client device 203, user 202 would likely pick up the phone. Further, while local client device 203 is ringing, speaker/microphone device 211, the closest speaker/microphone to user 202, would not announce to user 202 that local client device 203 is receiving a phone call, as gateway device 206 has determined that user 202 is in the same room as local client device 203, and local client device 203 is not in vibrate mode.

However, if user 204, operating client device 205, made a call to local client device 203 while local client device 203 was in vibrate mode, controller 320 would execute instructions stored on memory 322 to cause gateway device 206 to transmit the caller credentials of user 204 to extender 208 and instructions to transmit the caller credentials of user 204 to speaker/microphone device 211, the closest speaker/microphone to user 202. Then, controller 311 would execute instructions stored on memory 312 to cause extender 208 to transmit the caller credentials to speaker/microphone device 211. As local client device 203 is in vibrate mode, user 202 may not hear the phone call, leading to speaker/microphone device 211 alerting user 202.

For example, presume that user 202 is in living room 400, along with local client device 203. Further, user 205, operating client device 204, makes a phone call to local client device 203. Gateway device 206, having determined that user 202 is located in living room 400, will determine if local client device 203 is in vibrate mode. More specifically, controller 301 will execute instructions stored on memory 302 causing local client device 203 to transmit a mode of operation signal to gateway device 206. Controller 320 will then execute instructions stored on memory 322 causing gateway device 206 to analyze the mode of operation signal and determine that local client device 203 is not in vibrate mode, meaning the ringer is active.

Returning to FIG. 1, if it is determined that the local client device is in vibrate mode (Y at S108), then the gateway device transmits the caller credentials to the extender (S112). This will be described in greater detail with reference to FIG. 2B.

FIG. 2B illustrates a communication network 200 at time/1 in accordance with aspects of the present disclosure.

As shown in FIG. 2B, communication network 200 additionally includes caller alert 230. Caller alert 230 is the signal that travels from local client device 203 through gateway device 206 and extender 208 to speaker/microphone device 210. A caller alert can be transmitted to any one of speaker/microphone device 210, 211, or 212.

For example, with reference to FIG. 2B, presume that gateway device 206 has received a mode of operation signal from local client device 203. Controller 320 will execute instructions stored on memory 322 causing gateway device 206 to analyze the mode of operation signal. If gateway device 206 analyzes the mode of operation signal and determines that local client device 203 is in vibrate mode, then gateway device 206 will transmit the caller credentials, obtained from local client device 203, to extender 208, shown as caller alert 230.

If it is determined that the local client device is not in vibrate mode (N at S108), then it is determined if the user is in the same room as the local client device (S110). This will be described in greater detail with reference to FIG. 4B.

FIG. 4B illustrates an example embodiment of residence 201 in accordance with aspects of the present disclosure. FIG. 4B additionally includes caller alert 230.

For example, with reference to FIG. 4B, presume user 204 is in kitchen 402, while local client device 203 is in living room 400. Further presume that user 204, operating client device 205, makes a phone call to local client device 203. Gateway device 206, having previously determined the location of user 202 within residence 201, will compare the location to that of local client device 203. More specifically, controller 320 would execute instructions stored on memory 322 to cause gateway device 206 to determine that user 204 is in a different room than local client device 203.

If it is determined that the user is in the same room as the local client device (Y at S110), then method 100 stops (S120). For example, with reference to FIG. 4A, presume that user 202 is in the same location as local client device 203. As user 202 is in the same location as local client device 203, and as local client device 203 has the ringer on, gateway device 206 will assume that user 202 is aware of the phone call, leading to method 100 stopping.

If it is determined that the user is not in the same room as the local client device (N at S110), then the gateway device transmits the caller credentials to the extender (S112). For example, with reference to FIG. 4B, presume user 204 is in kitchen 402, while local client device 203 is in living room 400. With gateway device determining that user 202 and local client device 203 are in different locations, and that local client device 203 is in vibrate mode, controller 320 will execute instructions stored on memory 322 causing gateway device 206 to transmit, via radio 324, the caller credentials and instructions to transmit the caller credentials to speaker/microphone device 210 to extender 208.

As shown in FIG. 4B, user 202 is located in kitchen 402. The nearest speaker/microphone is speaker/microphone device 210. Thus, gateway device 206 transmits the caller credentials to extender 208, and instructs extender 208 to transmit the caller credentials of user 204 to speaker/microphone device 210, the closest speaker/microphone to user 202. However, if user 202 was located somewhere else in residence 201, controller 320 would execute instructions stored on memory 322 causing gateway device 206 to determine the closest speaker/microphone to user 202. For example, if user 202 was in bedroom 404, gateway device 206 would transmit the caller credentials of user 204 to extender 208, and instruct extender 208 to transmit the caller credentials of user 204 to speaker/microphone device 212.

Returning to FIG. 1, after the gateway device transmits the caller credentials to the extender (S112), the extender transmits the caller credentials to the speaker/microphone nearest to the user (S114). For example, presume that user 202 is located in living room 400 with local client device 203, as shown in FIG. 4A. However, local client device 203 is in vibrate mode. Controller 310 will execute instructions stored on memory 312 causing extender 308 to transmit the caller credentials of user 204 to speaker/microphone device 211, the closest speaker/microphone to the location of user 202. This is to ensure that the user hears the notification.

Returning to FIG. 1, after the extender transmits the caller credentials to the speaker/microphone nearest to the user (S114), the speaker notifies user of the phone call and prompts user action (S116). For example, presume that user 202 is located in living room 400 with local client device 203, as shown in FIG. 4A, and that local client device 203 is in vibrate mode. Further, extender 208 has transmitted the caller credentials to speaker/microphone device 211, the closest speaker/microphone to user 202. Speaker/microphone device 211 is configured to transmit sound to user 202 alerting them of the phone call to local client device 203, non- limiting examples of sounds being a ringtone and an audio message detailing the identity of the caller. Speaker/microphone device 211 will then wait for a voice command from user 202.

Returning to FIG. 1, after the speaker notifies user of the phone call and prompts user action (S116), the user interacts with the microphone (S118). For example, presume that speaker/microphone device 211 is ringing, alerting user 202 of the phone call to local client device 203. Speaker/microphone device 211 is configured to receive audio input from user 202 and analyze the audio inputs. Presume that user 202, hearing the ringing from speaker/microphone device 211, uses a predetermined command to answer the call through speaker/microphone device 211, a non-limiting example of a predetermined command being “answer call”. User 202 can answer the call through speaker/microphone device 211 and not worry about locating local client device 203. Non-limiting examples of other commands user 202 can use to acknowledge the call may include “decline call”, “hold the call”, or “callback later”.

Speaker/microphone device 211 is configured to analyze voice commands from user 202. Speaker/microphone can read the response of user 202 through numerous methods, non-limiting examples of which include the user: responding after a predetermined number of rings (e.g., 3 rings); using a keyword (e.g., Alexa); or responding after a predetermined period of time (e.g., 5 seconds).

In some embodiments, speaker/microphone device 211 may be equipped with a device able to detect images. In such an embodiment, speaker/microphone device 211 would be able to respond to gestures from user 202. For example, presume that speaker/microphone device 211 is equipped with an image detector. While speaker/microphone device 211 is ringing, user 202 displays a thumbs up gesture to the image detector. Speaker/microphone would analyze the gesture and determine that user 202 would like to answer the phone call.

In some embodiments, speaker/microphone device 211 may provide voice commands to user 202, reminding them of their options. For example, presume that speaker/microphone device 211 is ringing, alerting user 202 of the phone call to local client device 203. Speaker/microphone device 211 may provide voice commands to user 202, non-limiting examples of voice commands including “answer the call”, “decline the call”, “hold the call”, or “call back later”.

Returning to FIG. 1, after the user interacts with the microphone (S118), method 100 stops (S120).

The non-limiting example embodiments discussed above include a user 202. However, it should be noted that in accordance with aspects of the present disclosure, gateway device 206 may operate in a similar manner for multiple persons within residence 201. In particular, in accordance with aspects of the present disclosure, a client device for each person may be associated with gateway device 206, wherein gateway device 206 will operate so as to enable method 100 for each client device of each respective person.

Sometimes, cell phone and mobile device owners will be preoccupied when they receive a phone call. In particular, elderly people or children are most susceptible to not paying attention to their mobile devices if they are not directly using them. This is especially true when they are preoccupied with another task, or when their mobile device is not directly on their person. Missing a phone call can be problematic when the incoming phone call is urgent. Further, the caller may panic and assume something is wrong if they were expecting the mobile device owner to answer. As such, there needs to be a way to immediately get the attention of a user when they are unable to answer the call to ensure that the incoming phone call is received.

In accordance with the present disclosure, an outside client device attempts to call a local client device. The local client device, connected to a gateway device, will transmit the caller credentials to the gateway device. The gateway device will determine the location of the local user who operates the local client device. The local client device will transmit a mode of operation signal to the gateway device, informing the gateway device about whether the local client device has the ringer on or off. If the ringer is off, the gateway device will transmit the caller credentials to an extender, to then be transmitted to a speaker/microphone device that is nearby the user. The speaker will alert the user of the phone call, and the microphone will accept audio input from the user. The user can then answer the call through the microphone. If the local client device has the ringer on, the gateway device will compare the location of the local client device to the location of the local user. If they are different, then the gateway device will transmit the caller credentials to the speaker/microphone nearest to the user, where the user will then respond to the call.

Thus, the present disclosure as disclosed allows a user to be notified of a phone call in situations where they are not near their mobile device, or when the ringer of the mobile device is turned off.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A media device for use with a wide area network, a local area network, a local client device, a second client device, a wireless speaker, and a user of the local client device, the second client device being configured to transmit an initiation communication to initiate communication with the local client device, the local client device being configured to receive the initiation communication and to transmit an alerting communication, the local client device being at a first location, the wireless speaker being configured to output a warning, said media device comprising:
a memory;
a communication system configured to receive the alerting communication from the local client device;
a processor configured to execute instructions stored on said memory to cause said media device to:
determine a user location of the user via the local area network;
determine a client device location of the local client device via the local area network; and
transmit, when the user location differs from the client device location, a speaker instruction to the wireless speaker to cause to the wireless speaker to output the warning, based on the alerting communication.

2. The media device of claim 1, wherein the wireless speaker is additionally configured to output a location instruction based on a location of the local client device, and wherein said processor is configured to execute instructions stored on said memory to additionally cause said media device to transmit a second instruction to the speaker, based on the alerting communication, to cause the speaker to output the location instruction.

3. The media device of claim 2, wherein said processor is configured to execute instructions stored on said memory to additionally cause said media device to transmit a predetermined message instruction to the wireless speaker to cause the wireless speaker to output a predetermined message.

4. The media device of claim 1, for use with a second wireless speaker being configured to output the alerting instruction, the wireless speaker being a first distance from the user location, the second wireless speaker being a second distance from the user location, wherein said processor is configured to execute instructions stored on said memory to additionally cause said media device to:
transmit the speaker instruction to the wireless speaker to cause to the wireless speaker to output the warning, based on the alerting communication, when the user location differs from the client device location and when the first distance is less than or equal to the second distance; and
transmit the speaker instruction to the second wireless speaker to cause to the second wireless speaker to output the warning, based on the alerting communication, when the user location differs from the client device location and when the first distance is greater than the second distance.

5. The media device of claim 1, further comprising:
a microphone configured to receive a vocal instruction from the user,
wherein said processor is configured to execute instructions stored on said memory to additionally cause said media device to, in response to receiving the vocal instruction from the user, creating a communication channel between the local client device and the second client device via the microphone. 6 The media device of claim 5, further comprising:
an image detector configured to detect a first image of the user,
wherein said processor is configured to execute instructions stored on said memory to cause said media device to transmit, when the user location differs from the client device location and when the image detector detects the first image of the user, a first speaker instruction to said microphone to cause to said microphone to open a communication channel with the second client device.

7. A method of using a media device with a wide area network, a local area network, a local client device, a second client device, a wireless speaker, and a user of the local client device, the second client device being configured to transmit an initiation communication to initiate communication with the local client device, the local client device being configured to receive the initiation communication and to transmit an alerting communication, the local client device being at a first location, the wireless speaker being configured to output a warning, said method comprising:
receiving, via a communication system, the alerting communication from the second client device;
determining, via a processor configured to execute instructions stored on a memory, a user location of the user via the local area network;
determining, via the processor, a client device location of the local client device via the local area network;
receiving, via the processor, the alerting communication from the local client device; and
transmitting, via the processor, when the user location differs from the client device location, a speaker instruction to the wireless speaker to cause to the wireless speaker to output the warning, based on the alerting communication.

8. The method of claim 7, wherein the wireless speaker is additionally configured to output a location instruction based on a location of the local client device, said method further comprising transmitting, via the processor, a location instruction to the speaker, based on the alert communication, to cause the speaker to output the location instruction.

9. The method of claim 8, further comprising transmitting, via the processor, a predetermined message instruction to the wireless speaker to cause the wireless speaker to output a predetermined message.

10. The method of claim 7, for additional use with a second wireless speaker being configured to output the alerting instruction, the wireless speaker being a first distance from the user location, the second wireless speaker being a second distance from the user location, said method further comprising:
transmitting, via the processor, the speaker instruction to the wireless speaker to cause to the wireless speaker to output the warning, based on the alerting communication, when the user location differs from the client device location and when the first distance is less than or equal to the second distance; and
transmitting, via the processor, the speaker instruction to the speaker to cause to the wireless speaker to output the warning, based on the alerting communication, when the user location differs from the client device location and when the first distance is greater than the second distance.

11. The method of claim 7, further comprising:
receiving, via a microphone, a vocal instruction from the user; and
in response to receiving the vocal instruction from the user, creating a communication channel between the local client device and the second client device via the wireless speaker.

12. The method of claim 11, further comprising:
detecting, via an image detector, one of a first image of the user and a second image of the user; and
transmitting, via the processor when the user location differs from the client device location and when the image detector detects the first image of the user, a first speaker instruction to microphone to cause to the microphone to open a communication channel with the second client device.

13. A non-transitory, computer-readable media having computer-readable instructions stored thereon, the computer-readable instructions being capable of being read by a media device for use with a wide area network, a local area network, a local client device, a second client device, a wireless speaker, and a user of the local client device, the second client device being configured to transmit an initiation communication to initiate communication with the local client device, the local client device being configured to receive the initiation communication and to transmit an alerting communication, the local client device being at a first location, the wireless speaker being configured to output a warning, wherein the computer-readable instructions are capable of instructing the client device to perform the method comprising:
receiving, via a communication system, the alerting communication from the second client device;
determining, via a processor configured to execute instructions stored on a memory, a user location of the user via the local area network;
determining, via the processor, a client device location of the local client device via the local area network;
receiving, via the processor, the alerting communication from the local client device; and
transmitting, via the processor, when the user location differs from the client device location, a speaker instruction to the wireless speaker to cause to the wireless speaker to output the warning, based on the alerting communication.

14. The non-transitory, computer-readable media of claim 13,
wherein the wireless speaker is additionally configured to output a location instruction based on a location of the local client device, and
wherein the computer-readable instructions are capable of instructing the client device to perform the method further comprising transmitting, via the processor, a location instruction to the speaker, based on the alert communication, to cause the speaker to output the location instruction.

15. The non-transitory, computer-readable media of claim 14, wherein the computer-readable instructions are capable of instructing the client device to perform the method further comprising transmitting, via the processor, a predetermined message instruction to the wireless speaker to cause the wireless speaker to output a predetermined message.

16. The non-transitory, computer-readable media of claim 13, for additional use with a second wireless speaker being configured to output the alerting instruction, the wireless speaker being a first distance from the user location, the second wireless speaker being a second distance from the user location, wherein the computer-readable instructions are capable of instructing the client device to perform the method further comprising:
transmitting, via the processor, the speaker instruction to the wireless speaker to cause to the wireless speaker to output the warning, based on the alerting communication, when the user location differs from the client device location and when the first distance is less than or equal to the second distance; and
transmitting, via the processor, the speaker instruction to the speaker to cause to the wireless speaker to output the warning, based on the alerting communication, when the user location differs from the client device location and when the first distance is greater than the second distance.

17. The non-transitory, computer-readable media of claim 13, wherein the computer-readable instructions are capable of instructing the client device to perform the method further comprising:
receiving, via a microphone, a vocal instruction from the user; and
in response to receiving the vocal instruction from the user, creating a communication channel between the local client device and the second client device via the wireless speaker.

18. The non-transitory, computer-readable media of claim 17, wherein the computer-readable instructions are capable of instructing the client device to perform the method further comprising:
detecting, via an image detector, one of a first image of the user and a second image of the user; and
transmitting, via the processor when the user location differs from the client device location and when the image detector detects the first image of the user, a first speaker instruction to microphone to cause to the microphone to open a communication channel with the second client device.
